(19) United States
(12) Patent Application Publication
(10) Pub. No.: US 2009/0019293 A1
(43) Pub. Date: Jan. 15, 2009

(54) AUTOMATIC DATA REVOCATION TO FACILITATE SECURITY FOR A PORTABLE COMPUTING DEVICE

(75) Inventor: Radia J. Perlman, Sammamish, WA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 11/865,308

(22) Filed: Oct. 1, 2007

Related U.S. Application Data
(60) Provisional application No. 60/948,874, filed on Jul. 10, 2007.

(51) Int. Cl. G06F 12/14

(52) U.S. Cl. 713/193

(57) ABSTRACT

Some embodiments of the present invention provide a system that automatically revokes data on a portable computing device. During operation, the system uses a key K₁ to encrypt data on the portable computing device. The system then attempts verify that the portable computing device is secure. If the attempt to verify that the portable computing device is secure fails, the system causes K₁ to be removed from the portable computing device.

### RELATED APPLICATION

This application hereby claims priority under 35 U.S.C. §119 to U.S. Provisional Patent Application No. 60/948,874, filed on 10 Jul. 2007, entitled “Laptop Data Revocation,” by inventor Radia J. Perlman.

### BACKGROUND

1. Field

The present invention generally relates to computer security. More specifically, the present invention relates to a method and an apparatus that automatically revokes data on a laptop when the laptop is lost or stolen.

2. Related Art

When a laptop (or any other type of portable computing device) is stolen, the data on the laptop can potentially be read by the thief. This can be a significant problem if the laptop contains sensitive data. If the laptop is stolen, it is desirable for sensitive data on laptop to be revoked, so that the sensitive data is unrecoverable. On the other hand, if the laptop is recovered, it is desirable for the data to be recoverable.

Laptops are commonly locked with a password to prevent unauthorized users from accessing them, but since users commonly forget passwords, there typically exists a password-bypass mechanism to unlock the laptop without losing all the data. Hence, a thief can potentially use this password-bypass mechanism to access sensitive data on the laptop. Even if no password-bypass mechanism is implemented, a password is likely to be guessable.

Hence, what is needed is a method and an apparatus that protects sensitive data on a laptop with a high-quality secret, such as a high-quality key (not just a password). Furthermore, it is desirable for a valid user to not lose data if the user forgets his password.

### SUMMARY

Some embodiments of the present invention provide a system that automatically revokes data on a portable computing device. During operation, the system uses a key K₁ to encrypt data on the portable computing device. The system then attempts to verify that the portable computing device is secure. If the attempt to verify that the portable computing device is secure fails, the system causes K₁ to be removed from the portable computing device.

In some embodiments, attempting to verify that the portable computing device is secure involves attempting to detect one or more of the following conditions: the portable computing device determines that it has been stolen through communication with a server; the portable computing device cannot communicate with the server for a period of time; a GPS component within the portable computing device indicates that the portable computing device has been moved; a pre-specified period of time has elapsed during normal operation of the portable computing device; the portable computing device is powered off; or the portable computing device is powered on.

In some embodiments, the system attempts to verify that the portable computing device is secure by periodically polling a server from the portable computing device.

In some embodiments, the portable computing device and the server store cryptographic information so that the server can authenticate to the portable computing device.

In some embodiments, when K₁ is removed from the portable computing device and it is subsequently determined that the portable computing device is possessed by a rightful owner, the system communicates with a server to restore K₁ on the portable computing device.

In some embodiments, restoring K₁ on the portable computing device involves a protocol in which the portable computing device authenticates to the server, and wherein the server returns K₁. In some embodiments, this protocol has perfect forward secrecy.

In some embodiments, restoring K₁ on the portable computing device involves using a shared authentication secret A to: authenticate the portable computing device to the server; and encrypt communications from the server to the portable computing device.

In one embodiment of the present invention, K₁ is stored in volatile storage on the portable computing device, and {K₁}K₂ is stored in non-volatile storage on the portable computing device, wherein K₂ is a blindable encryption key, and wherein a corresponding decryption key is stored on the server. In this embodiment, causing K₁ to be removed from the portable computing device involves removing K₁ from volatile storage on the portable computing device. Moreover, restoring K₁ on the portable computing device involves blinding {K₁}K₂, and sending the resulting quantity to the server to be blindly decrypted, which causes the server to send back the blinded K₁, which the portable computing device unblinds to retrieve K₁.

In some embodiments, the portable computing device can include: a laptop computer system; a cellular telephone; a personal digital assistant; or a device controller.

### BRIEF DESCRIPTION OF THE FIGURES

FIG. 1 illustrates a system which includes a laptop and a server that communicate over a network in accordance with an embodiment of the present invention.

FIG. 2 presents a flow chart illustrating the process of polling a server in accordance with an embodiment of the present invention.

FIG. 3 presents a flow chart illustrating the process of restoring a key on a laptop in accordance with an embodiment of the present invention.

FIG. 4 presents a flow chart illustrating a more-efficient process for restoring a key on a laptop in accordance with another embodiment of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed. Overview

In one embodiment of the present invention, a server S, managed by the information technology department of a company, or a service that end users can contract with on their own, knows a high-quality secret for each laptop L, and the data on each laptop can be unlocked with the associated high-quality secret. If a laptop is reported stolen, the server will not enable the laptop.

Note that a policy can be set for a given laptop L as to whether L will need to talk to S every time the screen is locked, periodically (say every few hours), etc.

In general, there can exist a number of policies governing when L will “forget” K₁. It could forget K₁ when the laptop is powered off, or when it is powered on (in case the powering off process precludes the forgetting of K₁), or even every hour or so when L is in use. This would mean that L would become unusable if L is not connected to a network, so a policy can be set to trade off security for convenience (if it is known that the user will be using L disconnected from a network for some amount of time). Moreover, different portions of data on the portable computing device can be encrypted with keys with different policies. Hence, for each key K that locks a portion of the data on the portable computing device, a variety of policies can be chosen to determine when the portable computing device will forget K.

In one embodiment of the present invention, in order to remain operational, a laptop L has to poll the server S to be reminded of K₁. This can be overlapped with forgetting K₁ so that while the laptop is in continual use the laptop can continue to function without disruption. If the laptop is reported stolen, S locks K₁ for that laptop, so the data cannot be read on that laptop. Note that S need not destroy K₁, since it is possible the laptop will be recovered, in which case K₁ can be reactivated.

In one embodiment of the present invention, the laptop can be activated with a password P. We assume that P might be brute-force guessable, and also the laptop data must be recoverable if the user forgets P.

Note that S can be a completely trusted server, which directly knows the secret for a laptop, or S could know a key with which the laptop's key is encrypted. Alternatively, S could know a blindable encryption and decryption function for L. (See SUN Microsystems Laboratory Technical Report No. TR-2005-140, entitled, “The Ephemerizer: Making Data Disappear,” February 2005.)

Suppose that sensitive data on a laptop is encrypted with a key K₁. One embodiment of the present invention uses the following protocol to retrieve K₁ at the laptop: Initially, the server S knows K₁ and the laptop L needs to know K₁ to operate. L can retrieve K₁ by performing an authenticated Diffie-Hellman exchange with S, wherein S returns K₁ to L, encrypted with the Diffie-Hellman shared key. This protocol is best done proactively and transparently without user involvement.

In another embodiment, {K₁}K₂ is initially stored in non-volatile storage on L and S knows K₂. In this embodiment, the above protocol applies except that S returns K₂ instead of K₁, and L uses K₂ to decrypt K₁.

In another embodiment, S knows a blindable K₂. In this embodiment, L blinds {K₁}K₂ and sends the result to S, which returns blinded K₁. (See the technical report cited above.)

Note that as long as the laptop knows K₁, it can operate without talking to S, and it uses K₁ to encrypt data going to the disk and to decrypt data coming off the disk.

If the laptop stores K₁ encrypted with a blindable function, then the communication with S need not be further encrypted or authenticated. In this case, the secret that S knows is not K₁, but rather some blindable encryption/decryption functions, such as the ones specified in the technical report cited above.

In one embodiment of the present invention, if L is reported stolen, S is told not to decrypt with its decryption function for that laptop, but S need not destroy that key, in case the laptop is recovered.

Embodiments of the present invention are described in more detail below.

### System

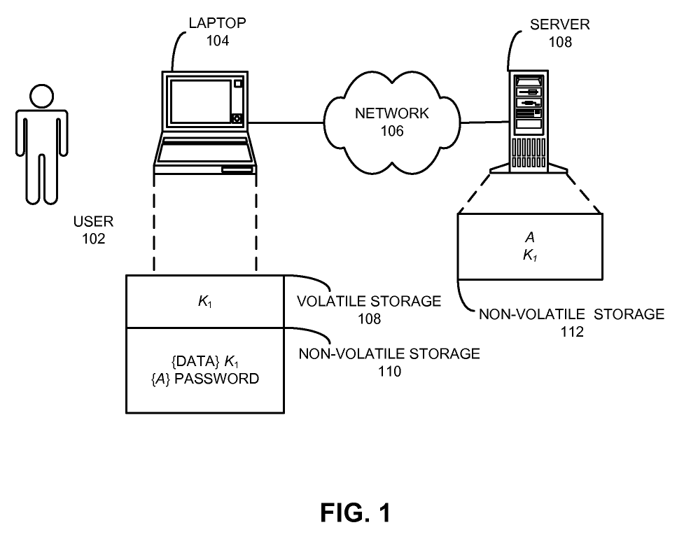

FIG. 1 illustrates a system which includes a laptop 104 which is operated by a user 102, and a server 108 which communicates with laptop 104 over a network 106 in accordance with an embodiment of the present invention.

Network 106 can generally include any type of wired or wireless communication channel capable of coupling together computing nodes. This includes, but is not limited to, a local area network, a wide area network, or a combination of networks. In one embodiment of the present invention, network 106 includes the Internet.

Laptop 104 can generally include any type of portable computing device, including, but not limited to, a laptop computer system, palmtop computer system, a personal digital assistant, a cellular telephone phone and a device controller.

Laptop 104 stores a key K₁ in volatile storage 108, wherein volatile storage 108 can be semiconductor memory. Laptop 104 also stores data D encrypted with K₁ (represented as “{DATA}K₁”) in non-volatile storage 110, wherein non-volatile storage 110 can be a disk drive. In this embodiment, server 108 stores K₁. Alternatively, S might not store K₁, but could instead store a decryption key K₂ for laptop 104, and laptop 104 stores K₁ encrypted with K₂ ({K₁}K₂) in non-volatile storage 110. Moreover, K₂ might be a public-private key pair, in which case laptop 104 can store a public key for K₂ and server 108 can store a corresponding private key for K₂.

Laptop 104 and server S can additionally store some means of authenticating to the other, which can be either a shared secret A, or a public key pair, where each side is configured with, or can verify the other side's public key.

Server 108 can generally include any computational node including a mechanism for servicing requests from a client for computational and/or data storage resources. Furthermore, server 108 includes mechanisms that facilitate managing keys for portable computer systems, such as laptop 104. Server 108 also stores the shared authentication secret A and the key K₂ in non-volatile storage 112.

### Polling Process

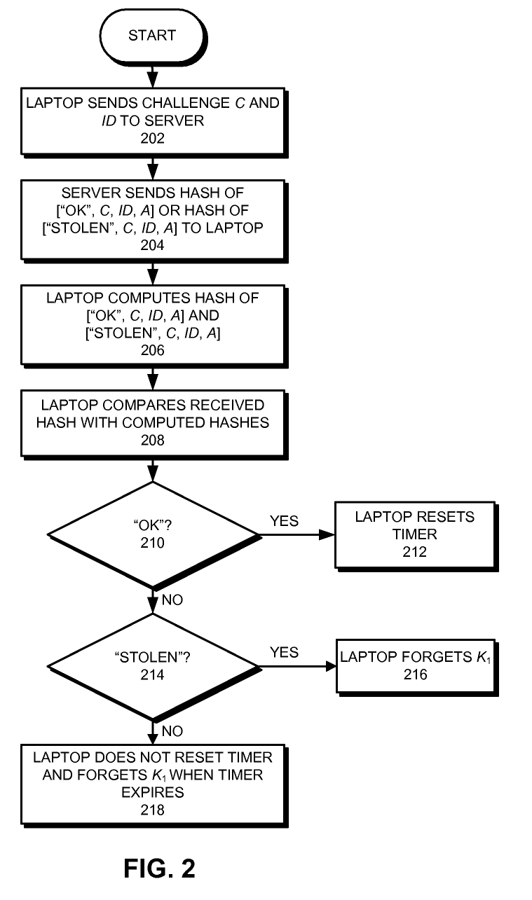

FIG. 2 presents a flow chart illustrating the process of polling a server in accordance with an embodiment of the present invention. At the start of this process, laptop 104 and server 108 share a high-quality authentication secret A. During this process, laptop 104 first sends a challenge C and an ID which identifies laptop 104 to server 108 (step 202).

Server 108 uses the ID to lookup A. Next, if the laptop has not been reported stolen, server 108 constructs and sends to laptop 104 a hash of the message “OK”, C, ID and A. Otherwise, if the laptop has been reported stolen, server 108 constructs and sends to laptop 104 a hash of the message “STOLEN”, C, ID and A (step 204).

Laptop 104 also computes the hash of “OK”, C, ID and A and also computes the hash of “STOLEN”, C, ID and A (step 206) and compares the hash received from server 108 with the computed hashes (step 208).

If the received hash matches the “OK” hash (YES at step 210), laptop 104 resets a timer (step 212). On the other hand, if the received hash matches the “STOLEN” hash (YES at step 214), laptop 104 forgets K₁ by erasing K₁ from non-volatile storage (step 216). Finally, if the received hash is garbage or if laptop 104 fails to receive a hash from server 108, laptop 104 does not reset the timer and subsequently forgets K₁ when the timer expires (step 214).

### Key-Restoration Process

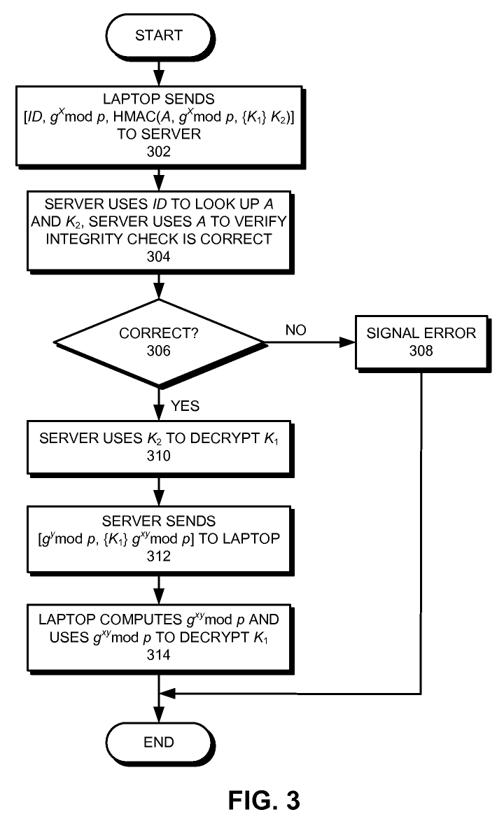

FIG. 3 presents a flow chart illustrating the process of restoring key K₁ on laptop 104 in accordance with an embodiment of the present invention.

At the start of the process, files on laptop 104 are encrypted with key K₁. Laptop 104 also stores a high-quality authentication secret A that it shares with server 108, and it uses A to authenticate itself to server 108. Note that laptop 104 stores A encrypted with a password P, and server 108 stores both A (the high-quality authentication secret) and K₁.

When user 102 logs into laptop 104, user 102 types the password P. Laptop 104 then uses P to decrypt A at which point laptop 104 knows A.

The next step is to retrieve K₁ from server 108. Again, recall that laptop 104 knows A, and server 108 knows A and K₁.

Note the embodiment of the present invention described below uses a variation of a Diffie-Hellman exchange authenticated with A. This is essentially a traditional Diffie-Hellman exchange, but with a cryptographic integrity check keyed with A.

First, laptop 104 computes and sends to server 108 the following items [ID, g^{x}mod p, HMAC(A, g^{x}mod p)] (step 302), wherein
(1) ID is an identifier for laptop 104; and
(2) g^{x}mod p HMAC(A, g^{x}mod p) is the Diffie-Hellman value g^{x}mod p authenticated with A.

Next, server 108 uses ID to look up A and K₁. Then, server 108 uses A to verify that the integrity check HMAC(A, g^{x}mod p) is correct (steps 304 and 306). If not, server 108 responds by signaling an error, or alternatively does not respond (step 308). (Note that HMAC( ) is a well-known function which generates a keyed-Hash Message Authentication Code.)

On the other hand, if the integrity check is correct at step 306, server 108 sends to laptop 104 [g^{x}mod p, {K₁} g^{xy}mod p], wherein,
(1) g^{x}mod p is a Diffie-Hellman value; and
(2) {K₁} g^{x}mod p is K₁ encrypted with the Diffie-Hellman secret (step 312).

Next, laptop 104 computes the Diffie-Hellman secret g^{xy}mod p and uses g^{xy}mod p to decrypt K₁ from {K₁} g^{xy}mod p (step 314).

Note that laptop 104 ideally forgets K₁ periodically, according to a policy that will ensure that K₁ will be gone by the time a laptop thief can start experimenting with laptop 104. If laptop 104 is always used online, this is fairly simple; just forget the secret periodically, say, every 10 minutes. But if laptop 104 is intended to be used on an airplane, the policy would have to be set appropriately.

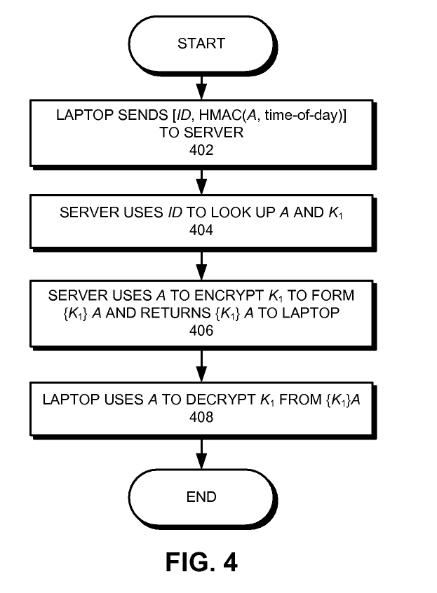

Note that the expense of the Diffie-Hellman exchange is probably not necessary in practice. Diffie-Hellman provides “perfect forward secrecy,” which means that if someone were to eavesdrop on the exchange in which the laptop recovers K₁, and later recovers A from the laptop, the thief would not be able to recover K₁. This is a fairly exotic threat, but we might as well implement the more secure version, although a less secure, more efficient technique (described with reference to FIG. 4 below) can be used as well.

Also note that if user 102 forgets P, it is not fatal. Server 108 knows A and K₁, so laptop 104 can be reconfigured with a new password.

In another embodiment of the present invention, instead of storing K₁, server 108 stores a blindable K₂, and laptop 104 stores {K₁}K₂ in nonvolatile storage. In this embodiment, to restore K₁, laptop 104 sends BLIND ({K₁}K₂) to server 108, and server 108 returns BLIND (K₁).

In yet another embodiment, laptop 104 stores {K₁}K₂ in nonvolatile storage and server stores K₂ but the embodiment does not use blind decryption. In this embodiment, communications between laptop 104 and server 108 operate as illustrated in FIG. 4, except that the server 108 returns K₂ to laptop 104 instead of K₁ and laptop 104 uses K₂ to decrypt K₁.

### Alternative Key-Restoration Process

FIG. 4 presents a flow chart illustrating a more-efficient alternative process for restoring key K₁ on laptop 104 in accordance with another embodiment of the present invention. In this alternative process, laptop 104 and server 108 share an authentication secret A.

In this alternative process, laptop 104 first sends something like the time-of-day integrity protected with A to server 108. For example, laptop 104 can send [ID, HMAC(A, time-of-day)] to server 108 (step 402). Next, server 108 uses ID to look up A and K₁ (step 404). Server 108 then uses A to encrypt K₁ and to form {K₁}A and returns {K₁}A to laptop 104 (step 406). Laptop 104 then uses A to decrypt {K₁}A to obtain K₁.

Note that this alternative process does not ensure perfect forward secrecy, but involves a less expensive computation.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for automatically revoking data on a portable computing device, comprising:
using a key K₁ to encrypt data on the portable computing device;
attempting to verify that the portable computing device is secure; and
if the attempt to verify that the portable computing device is secure fails, causing K₁ to be removed from the portable computing device.

2. The method of claim 1, wherein attempting to verify that the portable computing device is secure involves attempting to detect one or more of the following conditions:
the portable computing device determines that the portable computing device has not been stolen through communication with a server;
the portable computing device cannot communicate with the server for a period of time;
a GPS component within the portable computing device indicates that the portable computing device has been moved;
a pre-specified period of time has elapsed during normal operation of the portable computing device;
the portable computing device is powered off; and
the portable computing device is powered on.

3. The method of claim 1, wherein attempting to verify that the portable computing device is secure involves periodically polling a server from the portable computing device.

4. The method of claim 3, wherein the portable computing device and the server store cryptographic information so that the server can authenticate to the portable computing device.

5. The method of claim 1, wherein when K₁ is removed from the portable computing device and it is subsequently determined that the portable computing device is possessed by a rightful owner, the method further comprises communicating with a server to restore K₁ on the portable computing device.

6. The method of claim 5, wherein the portable computing device and the server store cryptographic information so that the portable computing device can authenticate to the server.

7. The method of claim 6, wherein the server stores cryptographic information for authenticating the portable computing device.

8. The method of claim 5, wherein the portable computing device and the server share an authentication secret A, and wherein communicating with the server to restore K₁ on the portable computing device involves using A to:
authenticate the portable computing device to the server; and
encrypt communications from the server to the portable computing device.

9. The method of claim 5,
wherein K₁ is stored in volatile storage on the portable computing device;
wherein {K₁}K₂ is stored in non-volatile storage on the portable computing device, wherein K₂ or a corresponding decryption key for K₂ is maintained by the server;
wherein causing K₁ to be removed from the portable computing device involves removing K₁ from volatile storage on the portable computing device; and
wherein communicating with the server to restore K₁ on the portable computing device involves,
communicating BLIND({K₁}K₂) to the server through a secure communication channel,
allowing the server to use K₂ or the corresponding decryption key for K₂ to decrypt {K₁}K₂ to restore K₁ and to return BLIND(K₁) to the portable computing device;
receiving BLIND(K₁) from the server; and
unblinding BLIND(K₁) to restore K₁ at the portable computing device.

10. The method of claim 1, wherein the portable computing device can include:
a laptop computer system;
a cellular telephone;
a personal digital assistant; and
a device controller.

11. A computer-readable storage medium storing instructions that when executed by a computer cause the computer to perform a method for automatically revoking data on a portable computing device, the method comprising:
using a key K₁ to encrypt data on the portable computing device;
attempting to verify that the portable computing device is secure; and
if the attempt to verify that the portable computing device is secure fails, causing K₁ to be removed from the portable computing device.

12. The computer-readable storage medium of claim 11, wherein attempting to verify that the portable computing device is secure involves attempting to detect one or more of the following conditions:
the portable computing device determines that the portable computing device has not been stolen through communication with a server;
the portable computing device cannot communicate with the server for a period of time;
a GPS component within the portable computing device indicates that the portable computing device has been moved;
a pre-specified period of time has elapsed during normal operation of the portable computing device;
the portable computing device is powered off; and
the portable computing device is powered on.

13. The computer-readable storage medium of claim 11, wherein attempting to verify that the portable computing device is secure involves periodically polling a server from the portable computing device.

14. The computer-readable storage medium of claim 13, wherein the portable computing device and the server store cryptographic information so that the server can authenticate to the portable computing device.

15. The computer-readable storage medium of claim 11, wherein when K₁ is removed from the portable computing device and it is subsequently determined that the portable computing device is possessed by a rightful owner, the method further comprises communicating with a server to restore K₁ on the portable computing device.

16. The computer-readable storage medium of claim 15, wherein the portable computing device and the server store cryptographic information so that the portable computing device can authenticate to the server.

17. The computer-readable storage medium of claim 16, wherein the server stores cryptographic information for authenticating the portable computing device.

18. The computer-readable storage medium of claim 15, wherein the portable computing device and the server share an authentication secret A, and wherein communicating with the server to restore K₁ on the portable computing device involves using A to:
authenticate the portable computing device to the server; and
encrypt communications from the server to the portable computing device.

19. The computer-readable storage medium of claim 15,
wherein K₁ is stored in volatile storage on the portable computing device;
wherein {K₁}K₂ is stored in non-volatile storage on the portable computing device, wherein K₂ or a corresponding decryption key for K₂ is maintained by the server;
wherein causing K₁ to be removed from the portable computing device involves removing K₁ from volatile storage on the portable computing device; and
wherein communicating with the server to restore K₁ on the portable computing device involves,
communicating BLIND({K₁}K₂) to the server through a secure communication channel,
allowing the server to use K₂ or the corresponding decryption key for K₂ to decrypt {K₁}K₂ to restore K₁ and to return BLIND(K₁) to the portable computing device;
receiving BLIND(K₁) from the server; and
unblinding BLIND(K₁) to restore K₁ at the portable computing device.

20. A portable computing device configured to automatically revoke data, comprising:
a processing engine;
a volatile memory;
a non-volatile memory;
an encryption mechanism configured to use a key K₁ to encrypt data on the portable computing device;
a determination mechanism configured to determine whether the portable computing device is secure; and
a key-removal mechanism, wherein if the attempt to determine whether the portable computing device is secure fails, the key-removal mechanism is configured to cause K₁ to be removed from the portable computing device.

21. The portable computing device of claim 20, wherein while attempting to determine whether the portable computing device is secure, the determination mechanism is configured to attempt to detect one or more of the following conditions:
the portable computing device determines that the portable computing device has not been stolen through communication with a server;
the portable computing device cannot communicate with the server for a period of time;
a GPS component within the portable computing device indicates that the portable computing device has been moved;
a pre-specified period of time has elapsed during normal operation of the portable computing device;
the portable computing device is powered off; and
the portable computing device is powered on

22. The portable computing device of claim 20, wherein while attempting to determine whether the portable computing device is secure, the determination mechanism is configured to poll a server.

23. The portable computing device of claim 22, further comprising a key-restoration mechanism, wherein when K₁ is removed from the portable computing device and it is subsequently determined that the portable computing device is possessed by a rightful owner, the key-restoration mechanism is configured to communicate with a server to restore K₁ on the portable computing device.

24. The portable computing device of claim 23, wherein the portable computing device and the server share an authentication secret A, and wherein while communicating with the server to restore K₁ on the portable computing device, the key-restoration mechanism is configured to use A to:
authenticate the portable computing device to the server; and
encrypt communications from the server to the portable computing device.

25. The portable computing device of claim 23,
wherein K₁ is stored in the volatile memory on the portable computing device;
wherein {K₁}K₂ is stored in non-volatile memory on the portable computing device, wherein K₂ or a corresponding decryption key for K₂ is maintained by the server;
wherein while causing K₁ to be removed from the portable computing device, the key-removal mechanism is configured to remove K₁ from the volatile memory on the portable computing device; and
wherein while communicating with the server to restore K₁ on the portable computing device, the key-restoration mechanism is configured to,
communicate BLIND({K₁}K₂) to the server through a secure communication channel,
allow the server to use K₂ or a corresponding decryption key for K₂ to decrypt {K₁}K₂ to restore K₁ and to return BLIND(K₁) to the portable computing device,
receive BLIND(K₁) from the server through the secure communication channel, and
unblind BLIND(K₁) to restore K₁ at the portable computing device.
